(19) United States
(12) Patent Application Publication
(10) Pub. No.: US 2015/0138837 A1
(43) Pub. Date: May 21, 2015

(54) MAGNETIC BALANCED CONVERTER WITH ISOLATION BARRIER

(71) Applicant: PR ELECTRONICS A/S, Rønde (DK)

(72) Inventor: Stig Alnøe Lindemann, Hojbjerg (DK)

(73) Assignee: PR ELECTRONICS A/S, Rønde (DK)

(21) Appl. No.: 14/413,840

(22) PCT Filed: Jul. 9, 2013
(86) PCT No.: PCT/DK2013/050232

§ 371 Date: Jan. 9, 2015

(30) Foreign Application Priority Data
Jul. 10, 2012 (DK) PA 2012 70419

(51) Int. Cl. H02M 3/26

(52) U.S. Cl. CPC H02M 3/26
USPC 363/15

(57) ABSTRACT

A converter with at least one primary side having a first set of coils magnetically coupled to at least one secondary side having at least a second set of coils, wherein the primary side is electrically isolated from the secondary side by an isolation barrier, wherein one of the secondary sides is configured to be connected to an external output unit, wherein the primary side is magnetically coupled to another secondary side having a third set of coils which coils are configured to be coupled to an external input unit, wherein the two secondary sides are electrically isolated from each other by a second isolation barrier, wherein the three sets of coils are magnetically coupled to each other via a common magnetic path. The converter provides an isolated current-to-current transfer between the input side and the output side which replicates the input current with high accuracy.

### BACKGROUND OF THE INVENTION

1. Field of the Invention

The present invention relates to a converter comprising at least one transformer, which converter comprises at least one primary circuit, which primary circuit is connected to at least a first set of primary coils, which converter further comprises at least one second primary circuit, which second primary circuit is connected to least a second set of primary coils, which converter comprises a secondary circuit, which circuit is connected to a third set of secondary coils, which first primary coils is electrically isolated from the secondary coils by an isolation barrier, which first and second primary coils are electrically isolated from each other by a second isolation barrier, which three sets of coils are magnetically coupled to each other via a common magnetic path.

2. Description of Related Art

It is well known within signal or power transformer systems to use an isolation barrier in a magnetic (or inductive) coupling to electronically isolate the primary side from the secondary side for protecting the circuitry on the secondary side and eliminating common-mode noise.

U.S. Patent Application Publication US 2008/0181316 A1 discloses a method for transferring power and information across an isolation barrier by transferring power across a power transfer isolation barrier between a primary circuit and a secondary circuit while maintaining isolation between the primary and secondary circuits, and transferring data between the primary circuit and the secondary circuit across a communications isolation barrier that is distinct from the power transfer isolation barrier. Feedback control signals are transferred via a secondary communications interface and a primary communications interface to a power control circuit at the primary side which controls the power transfer. The primary communications interface is powered by a second primary circuit connected to the power transfer isolation barrier. This configuration requires the use of two separate isolation barriers and requires additional communications components to be implemented at both the primary side and the secondary side in order to regulate the power transfer.

U.S. Pat. No. 3,896,366 A discloses a converter comprising a transformer having three electrically isolated sets of magnetically coupled coils. The first set of coils is driven by an external power source. The second set of coils is coupled to an external input unit through a current limiter and a rectifier. The third set of coils is coupled to an external output unit through a rectifier. This patent does not deal with the problem of providing a converter system which can replicate the input current at the output side with high accuracy.

### SUMMARY OF THE INVENTION

It is an object of the invention to provide a converter capable of replicating an input current with high precision.

It is an object of the invention to provide a converter transferring energy from a primary unit to two secondary units having a common magnetic path.

It is an object of the invention to provide a converter capable of balancing the magnetic coupling without using a feedback loop across the isolation for regulation of the magnetic coupling.

The object can be fulfilled by a converter of the initially mentioned type that has been modified so the first set of coils can be connected to a switch mode circuit, which switch mode circuit can be configured to drive the primary circuit and the first set of primary coils.

This provides a converter particularly suited for current-to-current transformation where the output side is electronically isolated from the input side. This provides an isolated current-to-current transfer between the secondary input side and the secondary output side. This enables the converter to replicate an externally applied input current to an isolated output current with high accuracy via regulation at the primary side. The output side may be connected to an external measurement resistance or impedance characteristic of an external load circuit. In one embodiment, the common magnetic path is a magnetic core. This enables the converter to have minimal energy transfer loss during operation. In another embodiment, the first isolation barrier and the second isolation barrier form parts of a single common isolation barrier.

According to one embodiment of the invention, the first set of coils is connected to a power regulation unit configured to be connected to an external power source. This enables the converter to regulate and magnetically balance the energy transfer of the converter through the common magnetic path between the primary side and the two secondary sides. This can reduce the energy loss between the primary side and the two secondary sides to a minimum.

According to an embodiment of the invention, the second set of coils is connected to a first rectifying circuit and the third set of coils is connected to a second rectifying circuit, and the two set of coils have opposite polarities. This enables the converter to split the energy transfer from the primary side between the two secondary sides through the common magnetic path.

According to a specific embodiment of the invention, at least one of the sets of coils may be connected to a threshold circuit configured to limit the output current or voltage range. This enables the range of the output current or voltage to be limited to a current or voltage threshold value having a low or high value, which in turns ensures a nominal operation of the converter during a power up scenario. The lower current threshold value may be 2 mA. Alternatively, the threshold circuit may be connected to the third set of coils instead and may limit the input range to an upper current or voltage threshold value, which in turns protects the converter e.g., against overshoots. The threshold circuit may be arranged at the primary side and may be connected to the first set of coils. The threshold circuit may in this embodiment be configured to limit the power regulation at the primary side, e.g., by defining an activation threshold value used to activate the regulation loop when the measured signal or the determined transfer error exceeds the activation threshold value.

According to an embodiment of the invention, the first set of coils may be connected to a switch mode circuit configured to drive the primary side. This enables the converter to indirectly control the output current which is set by the input current and the magnitude of the externally applied voltage to the switch mode circuit. Alternatively, the output current may be controlled by adjusting the duty cycle or the frequency of the switch mode output signal. In one embodiment, the output current may be controlled by using a spread spectrum signal to control the operation of the switch mode circuit.

In another embodiment, the dead time between the leading edge and the trailing edge of the pulsed signal applied to the transformer may be adjusted so that the energy transfer is balanced.

According to a specific embodiment of the invention, the first set of coils may further be connected to a measuring circuit, which is configured to measure the amount of energy through the first set of coils and connected to a power conversion unit, which is connected to the switch mode circuit and configured to drive the switch mode circuit based on the measured signal from the measuring circuit. This enables the amount of energy transferred to each of the secondary sides to be measured and used to regulate the operation of the switch mode circuit. This enables the energy transfer to be balanced so that the input current is equal to the output current. In a simple embodiment, the measuring unit may be a low impedance resistor connected in series with the first set of coils. The signal from the measuring circuit may be digitalized, e.g., by an AC-DC converter, before being transmitted to the power conversion unit.

According to a specific embodiment of the invention, the measuring circuit is connected to a processor unit, which in turns is connected to the power conversion unit and the switch mode circuit, where the processor unit is configured to control the operation of the switch mode circuit and the power conversion unit. This enables the processor unit to manage the regulation of the energy transfer from the primary side to the two secondary sides and in turns the output current. The regulation may be performed automatically according to one or more reference parameters stored in the processor unit.

In one embodiment, one or more of the reference parameters may be adjusted using a user interface connected to the processor unit. This allows the processor unit to synchronise the demodulation (sampling) of the measured signal with the control of the switch mode circuit. By using a successive approximation routine (SAR) AD-converter the measured signal may be demodulated with the same margin of error. The SAR AD-converter is preferred when the measured signal has a frequency higher than the sampling rate capacity of the AD-converter, since the sample rate of the SAR AD-converter is limited by the conversion rate rather than the actual sampling time. The processor unit then processes the sampled signal using an algorithm implemented in the processor unit, before transmitting a control signal to the power conversion unit, e.g., via a DA-converter. In a preferred embodiment, the sampled signal is processed using a signal processing algorithm configured to compensate for various errors, tolerances or other nonlinearities of the system, thereby allowing the converter to more accurately replicate the input current on the output side.

According to a second specific embodiment, the measuring circuit is connected to a switch, which in turns is connected to the power conversion unit and the processor unit, where the processor unit controls the operation of the switch. This enables the processor unit to demodulate the measured signal using a switch where the control of the switch is synchronized to the operation of the switch mode circuit, thereby eliminating the need for the measured signal to be sampled by an AD-converter and optionally de-sampled by a DA-converter.

According to a third specific embodiment of the invention, the switch is connected to a signal processing unit, which in turns communicates with the power conversion unit and the processor unit, where the processor unit controls the operation of the signal processing unit.

This enables the processor unit to compensate for various errors, tolerances or other nonlinearities of the system using the signal processing unit, thereby allowing the converter to more accurately replicate the input current on the output side. The signal processor unit may be controlled according to a signal processing algorithm implemented in the processor unit.

According to one embodiment of the invention, the processor unit comprises a linearization function configured to compensate for a transfer error between the input side and the output side at a given input signal.

This enables the processor unit to adjust the current-to-current conversion so that the conversion scheme follows a linearized function. The processor unit may alternatively use a different non-linearization function to compensate for any transfer error between the input side and the output side. The linearization function may be configured to a multi-dimensional function capable of compensating for a transfer error at a given input current or which impedance the input current passes. In a preferred embodiment, the linearization function is implemented as a complete look-up table or a compressed look-up table using an interpolation method/function to represent any value between at least two table values. This enables the linearization function to be implemented during manufacture and/or updated during the lifetime of the converter, if needed.

An embodiment of the invention will now be described, by way of example only, with reference to the accompanying drawings.

### BRIEF DESCRIPTION OF THE DRAWINGS

FIG. 1 shows a configuration of the converter according to the invention,

FIG. 2 shows a first exemplary embodiment of the configuration of the converter,

FIG. 3 shows a second embodiment of the configuration of the primary side, and

FIG. 4 shows a third embodiment of the configuration of the primary side.

### DETAILED DESCRIPTION OF THE INVENTION

In the following text, the figures will be described one by one and the different parts and positions seen in the figures will be numbered with the same numbers in the different figures. Not all parts and positions indicated in a specific figure will necessarily be discussed together with that figure.

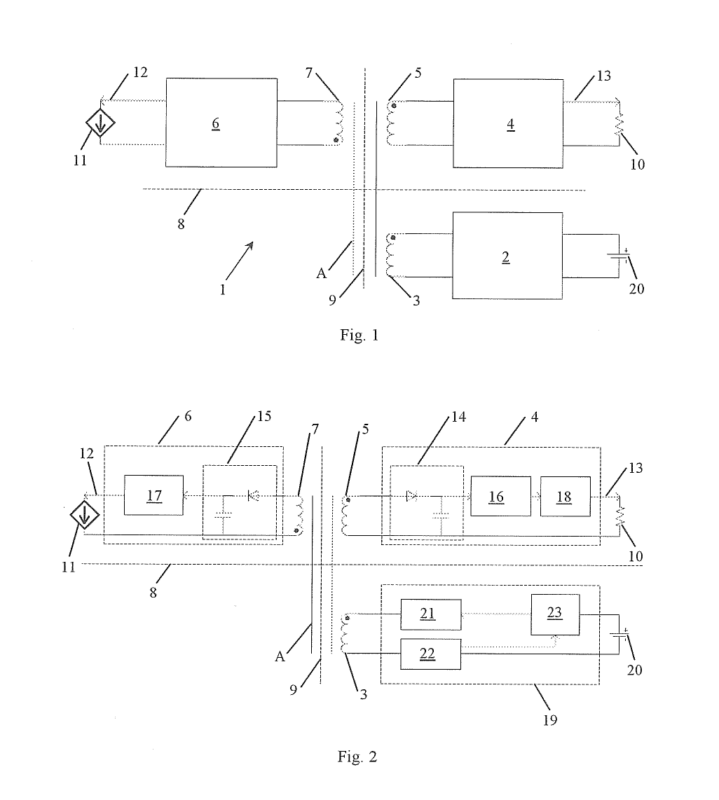

FIG. 1 shows one exemplary configuration of the converter according to the invention. The converter 1 comprises at least one primary side 2 having a first set of coils 3 magnetically coupled to at least one secondary side 4, 6 having at least a second set of coils 5, 7. In a preferred embodiment, the converter comprises a primary side 2 magnetically coupled to two secondary sides 4, 6 having a second set of coils 5 and a third set of coils 7 respectively. The primary side 2 is electronically isolated from the secondary sides 4, 6 by at least one isolation barrier 8. The secondary sides 4, 6 are electronically isolated from each other by at least one isolation barrier 9. The isolation barriers 8, 9 may be separate isolation barriers or form parts of a common isolation barrier. The primary side 2 and the secondary sides 4, 6 are magnetically coupled to each other via a common magnetic path in the form of a common magnetic core A. The sets of coils 3, 5, 7 may be arranged in and/or around the magnetic core in at least one predetermined pattern. The configuration and materials of the isolation barriers 8, 9 may determined according to the desired use and placement of the converter.

The converter may be configured as a current-to-current converter which may be configured to transfer a DC input current to a DC output current. The DC-current may be superimposed with an AC-current. One of the secondary sides is configured to be connected to an external output unit 10 in the form of a measurement resistance or impedance or another suitable load circuit or load unit. The other secondary side 6 is configured to be connected to an external input energy source 11 in the form of a current source, a voltage source or another suitable energy source. The converter is in a preferred embodiment configured so that it provides an isolated current-to-current transformation between the input side 6 capable of being connected/coupled to a DC current source and an output side 4 capable of being connected/coupled to a load unit/circuit. This enables the input current 12 to be duplicated on the output side 4 in the form of an output current 13 which replicates the input current 12 with high precision.

FIG. 2 shows a first exemplary embodiment of the configuration of the converter. The secondary side 4 may comprise a rectifying circuit 14 in the form a current rectifying circuit. The rectifying circuit 14 may in one embodiment comprise an arrangement of rectifying diodes, capacitors and/or other suitable components. The second set of coils 5 may be connected to the rectifying circuit 14 so that the coils 5 have a polarity in a first predetermined direction, as shown in FIG. 2.

The secondary side 6 may comprise a rectifying circuit 15 in the form a current rectifying circuit. The rectifying circuit 15 may have the same configuration as the rectifying circuit 14. The third set of coils 7 may be connected to the rectifying circuit 15 so that the coils 7 have a polarity in a second predetermined direction which is opposite to the first direction, as shown in FIG. 2. This enables the converter to split the energy transfer from the primary side 2 between the two secondary sides 4, 6.

A signal processing circuit 16 may be arranged between the rectifying circuit 14 and the external output unit 10. The signal processing circuit 16 may comprise a smoothing circuit (not shown) and/or other known components arranged so that they perform sufficient noise suppression, smoothening of the output signal 13 or other relevant functions. A second signal processing circuit 17 may be arranged between the rectifying circuit 15 and external input source 11. This signal processing circuit 17 may comprise a smoothing circuit (not shown), filter means and/or other known components arranged so that they perform sufficient noise suppression, smoothening of the input signal 12 or other relevant functions. The two signal processing circuits 16, 17 may have different or the same configuration which may be determined according to a predetermined set of specifications.

A threshold circuit 18 may be connected to the rectifying circuit 14 and may be configured to limit the output current 13 or voltage range according to a threshold value. The threshold circuit 18 may be configured so that it ensures a nominal operation of the converter during a power up scenario. The threshold value may be 2 mA. Alternatively, the threshold circuit 18 may be connected to the third set of coils 7 instead and may limit the input current or voltage range to an upper current or voltage threshold value, which in turns protects the converter against overshoots. The threshold circuit 18 may be arranged at the primary side 2 and may be connected to the first set of coils 3. The threshold circuit 18 may in this embodiment be configured to limit the power regulation at the primary side 2, e.g., by defining an activation threshold value used to activate the regulation loop when the measured signal or the determined transfer error exceeds the activation threshold value. The threshold circuit 18 may be configured to compare this input signal to the threshold value and either keep the output signal at zero until the output signal exceeds the threshold value or clip off the output signal when it exceeds the threshold value.

The first set of coils 3 at the primary side 2 may be connected to a power regulation unit 19 capable of being connected to an external power source 20 in the form of a DC voltage source. The power regulation unit 19 is configured to magnetically balance the energy transfer through the common magnetic path between the primary side 2 and the two secondary sides 4, 6. The system (the different sides 2, 4, 6) is defined to be in balance when the input current 12 is equal to the output current 13.

In one embodiment, a switch mode circuit 21 may be connected to one end of the first set of coils 3. The switch mode circuit 21 may be configured to drive the primary side 2. The output current 13 is set by the input current 12 and the magnitude of the externally applied voltage to the switch mode circuit 21. The switch mode circuit 21 may regulate the output current 13 by adjusting the magnitude of the applied voltage, the duty cycle or the frequency of the switch mode output signal.

A measuring circuit 22 may be connected to the other end of the first set of coils 3 and the power source 20. The measuring circuit 22 may be configured to measure the amount of energy passing through the first set of coils 3 and may transmit the measured signal to a power conversion unit 23. The power conversion unit 23 may be configured to drive the switch mode circuit 21 based on the measured signal from the measuring circuit 22. The power source 20 may apply power to the power conversion unit 23.

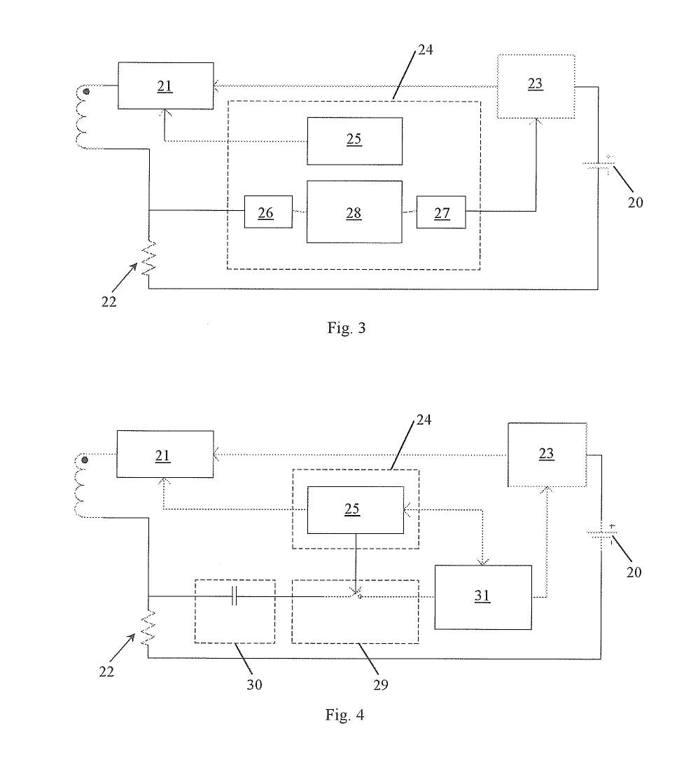

FIG. 3 shows a second embodiment of the configuration of the primary side 2. The measuring circuit 22 may in a simple embodiment be configured as a high impedance load where the measured signal is defined as the signal between the first set of coils 3 and the resistor, as shown in FIG. 3. The measured signal may be transmitted to e.g., an AD-converter so that the signal is digitalized before being transmitted to the power conversion unit 23.

In this embodiment, a processor unit 24 may be connected to the switch mode circuit 21, the power conversion unit 23 and the measuring unit 22 for receiving the measured signal. The processor unit 24 may be configured to control the operation of the switch mode circuit 21 via control logics or a control algorithm 25 implemented in the processor unit 24. The processor unit 24 is configured to manage the energy transfer from the primary side 2 to the secondary sides 4, 6. This management may be performed automatically according to one or more reference parameters stored in the processor unit 24 wherein one or more of the reference parameters may be adjusted using a user interface (not shown) connected to the processor unit 24.

The processor unit 24 may be configured to control the operation of the power conversion unit 23 based on the measured signal. The measured signal may be demodulated/sampled and synchronized according to the control signal transmitted to the switch mode circuit 21. In one embodiment, an AD-converter 26 using a successive approximation routine (SAR) to sample the measured signal may be arranged between the processor itself and measuring unit 22. If needed, a DA-converter 27 may be arranged between the processor itself and the power conversion unit 23. The configuration of the SAR AD-converter 26 may be determined according the waveform characteristics of the measured signal.

The processor unit 24 then processes the sampled signal using an algorithm implemented in the processor unit 24 before transmitting a control signal to the power conversion unit 23, e.g., via the DA-converter 27. In a preferred embodiment, the sampled signal is processed using a signal processing algorithm 28 configured to compensate for various errors, tolerances, nonlinearities or other transfer errors of the system.

FIG. 4 shows a third embodiment of the configuration of the primary side 2. A switch 29 may be connected to the measuring circuit 22 and the power conversion unit 23. The operation of the switch 29 may be controlled by the processor unit 24 using either the same control means 25 which controls the operation of the switch mode circuit 21, or separate control means (not shown) in the form of control logics or an control algorithm implemented in the processor unit 24. The operation of the switch 29 may be synchronized according to the control signal transmitted to the switch mode circuit 21. A sample/hold circuit may be used instead of the switch 29.

Filter means 30 in the form of a capacitor may be arranged between the switch 29 and the measuring unit 22 so that only AC-signals are transmitted to the switch 29.

A second signal processing unit 31 may be arranged between the switch 29 and the power conversion unit 23. The signal processing unit 31 may be configured to communicate with the processor unit 24. The signal processing unit 31 may transmit and/or receive data, such as control signals, measurements or other signals, which may be used to control the operation of the signal processing unit 31. The signal processing unit 31 may be configured to compensate for various errors, tolerances, nonlinearities or other transfer errors of the system. The signal processing unit 31 may be controlled according to a signal processing algorithm (not shown) implemented in the processor unit 24.

The processor unit 24 may in the embodiments shown in FIGS. 3 & 4 comprise a linearization function configured to compensate for a transfer error (incl. other errors, tolerances or nonlinearities) between the input side 6 and the output side 8 at a given input current 12. In a preferred embodiment, the linearization function is implemented as a complete look-up table or a compressed look-up table using an interpolation method/function to calculate any value between at least two table values. The linearization function may be updated or uploaded via the user interface connected to the processor unit 24.

In one embodiment, the number of components used in the switch mode circuit 21, the power conversion unit 23 and the processor unit 24 may be reduced by implementing the control components/intelligence configured to collect process and analyze a number of signals in the system, e.g., the measured signals, in a single processor unit. The single processor unit performs all the control functions/operations of the system and generates the control signals used to control/activate the controlled components in the switch mode circuit 21, the power conversion unit 23 and the processor unit 24. The implementation of the switch mode circuit 21, the power conversion unit 23 and the processor unit 24 may be done by any known implementation topology, such as the SEPIC-topology. This enables the data processing to be preformed digitally so that the demodulation of the measured signal and the control signals transmitted to the switch mode circuit can be synchronized more accurately and thus reducing the noise generated in the system. This would also lower the manufacturing cost of the system.

The invention is not limited to the embodiments described herein, and may be modified or adapted without departing from the scope of the present invention as described in the patent claims below.

What is claimed is:

1. A converter (1) comprising at least one transformer, which converter comprises at least one primary circuit (2), which primary circuit (2) is connected to at least a first set of primary coils (3), which converter further comprises a second primary circuit (4), which second primary circuit (4) is connected to a second set of primary coils (5), which converter comprises a secondary circuit (6), which circuit (6) is connected to a third set of secondary coils (7), which first and second primary coils (3, 5) are electrically isolated from the secondary coils (7) by an isolation barrier (9), which first and second primary coils (3, 5) are electrically isolated from each other by a second isolation barrier (8), which three sets of coils (3, 5, 7) are magnetically coupled to each other via a common magnetic path (A), wherein that the first set of coils (3) is connected to a switch mode circuit (21), which switch mode circuit (21) is configured to drive the primary circuit (2, 19) and the first set of primary coils (3), whereby the converter (1) is configured to replicate an externally applied input current (13) to an isolated output current (12) with high accuracy via regulation at the primary circuit (2).

2. A converter (1) according to claim 1, wherein the switch mode circuit (21) is connected an external power source (20).

3. A converter (1) according to claim 1 wherein the second set of coils (5) is connected to a first rectifying circuit (14) and the third set of coils (7) is connected to a second rectifying circuit (15), and that the two set of coils have opposite polarities.

4. A converter (1) according to claim 3, wherein at least one of the sets of coils (3, 5, 7) is connected to a threshold circuit (18) configured to limit the output current or voltage range.

5. A converter (1) according to claim 4, wherein the first set of coils (3) is further connected to a measuring circuit (22), which is configured to measure the amount of energy through the first set of coils (3) and connected to a power conversion unit (23), which is connected to the switch mode circuit (21) and configured to drive the switch mode circuit (21) based on the measured signal from the measuring circuit (22).

6. A converter (1) according to claim 5, wherein the measuring circuit (22) is connected to a processor unit (24), which in turns is connected to the power conversion unit (23) and the switch mode circuit (21), where the processor unit (24) is configured to control the operation of the switch mode circuit (21) and the power conversion unit (23).

7. A converter (1) according to claim 7, wherein the measuring circuit (22) is connected to a switch (29), which in turns is connected to the power conversion unit (23) and the processor unit (24), where the processor unit (24) controls the operation of the switch (29).

8. A converter (1) according to claim 7, wherein the switch (29) is connected to a signal processing unit (31), which in turns communicates with the power conversion unit (23) and the processor unit (24), where the processor unit (24) controls the operation of the signal processing unit (31).

9. A converter (1) according to claim 7, wherein the processor unit (24) comprises a linearization function configured to compensate for a transfer error between the input side and the output side at a given input signal.

10. A converter (2) according to claim 9, wherein the switch mode circuit (21) is connected an external power source (20).
